(19) United States
(12) Patent Application Publication
(10) Pub. No.: US 2017/0075271 A1
(43) Pub. Date: Mar. 16, 2017

(54) IMAGE FORMING APPARATUS AND IMAGE FORMING METHOD FOR FORMING TONER IMAGES BASED AT LEAST IN PART ON TONER QUALITIES OR CHARACTERISTICS

(71) Applicant: FUJI XEROX CO., LTD., Tokyo (JP)

(72) Inventor: Toru IWANAMI, Kanagawa (JP)

(73) Assignee: FUJI XEROX CO., LTD., Tokyo (JP)

(21) Appl. No.: 15/040,827

(22) Filed: Feb. 10, 2016

(30) Foreign Application Priority Data
Sep. 11, 2015 (JP) 2015-180076

(51) Int. Cl. G03G 15/00

(52) U.S. Cl. CPC G03G 15/5016

(57) ABSTRACT

An image forming apparatus includes a toner image forming section, a selection section, and a performing unit. The toner image forming section forms a toner image. The selection section allows a user to select a condition regarding a time at which the toner image forming section starts formation of the toner image, after a toner storage section that stores a toner is replaced. The performing unit performs formation of the toner image by the toner image forming section, in accordance with the selected condition.

### CROSS-REFERENCE TO RELATED APPLICATIONS

This application is based on and claims priority under 35 USC 119 from Japanese Patent Application No. 2015-180076 filed Sep. 11, 2015.

### BACKGROUND

(i) Technical Field

The present invention relates to an image forming apparatus and an image forming method.

(ii) Related Art

In an image forming apparatus such as a copier and a printer, which uses an electrophotographic process, for example, a photoreceptor which is formed to have a drum shape is uniformly charged. The charged photoreceptor is exposed to light which is controlled based on image information, and thus, an electrostatic latent image is formed on the photoreceptor. A developing device forms (which will be referred to as “develops” below) a visible image (toner image) with a toner by using the formed electrostatic latent image. The toner image is transferred to a recording material and the transferred toner image is fixed by the fixing device, and thus, an image is formed.

### SUMMARY

According to an aspect of the invention, an image forming apparatus includes a toner image forming section, a selection section, and a performing unit. The toner image forming section forms a toner image. The selection section allows a user to select a condition regarding a time at which the toner image forming section starts formation of the toner image, after a toner storage section that stores a toner is replaced. The performing unit performs formation of the toner image by the toner image forming section, in accordance with the selected condition.

### BRIEF DESCRIPTION OF THE DRAWINGS

Exemplary embodiments of the present invention will be described in detail based on the following figures, wherein:

FIG. 1 is a diagram illustrating an outline of an image forming apparatus according to an exemplary embodiment;

FIG. 2 illustrates a cross-sectional side view of a developing device;

FIG. 3 illustrates a top view of the developing device when FIG. 2 is viewed from a direction indicated by III;

FIG. 4 is a diagram showing comparison between (i) the quantities of a supplied toner per unit time in an image forming apparatus in which a toner cartridge is relatively close to a developing device of an image forming unit and (ii) the quantities of a supplied toner per unit time in an image forming apparatus in which the toner cartridge is relatively far from the developing device;

FIG. 5A is a diagram illustrating a distribution of a toner in the toner cartridge in a case where the quantity of the toner stored in the toner cartridge is relatively large and that in a case where the quantity of the stored toner is relatively small;

FIG. 5B is a diagram showing comparison of the quantities of the supplied toner per unit time in Case A to Case D, with each other;

FIG. 6 is a block diagram illustrating a functional configuration example of a control unit;

FIG. 7 is a diagram illustrating an example of a screen displayed on a UI when there is no toner;

FIG. 8 is a diagram illustrating an example of a screen displayed on the UI after the toner cartridge is replaced;

FIG. 9 is a diagram illustrating a relationship, after the toner cartridge is replaced, between an elapsed time from a start of a supply of the toner and the quantity of the supplied toner;

FIGS. 10A to 10C illustrate examples in which recovery periods of time are actually predicted;

FIG. 11 is a diagram illustrating a relationship, after the toner cartridge is replaced, between the elapsed time from a start of a supply of the toner and an image density allowing a start of image formation;

FIG. 12 is a flowchart illustrating a normal operation of the control unit;

FIG. 13A is a flowchart illustrating a recovery operation of the control unit;

FIG. 13B is a flowchart illustrating the recovery operation of the control unit;

FIG. 13C is a flowchart illustrating the recovery operation of the control unit;

FIG. 13D is a flowchart illustrating the recovery operation of the control unit; and

FIG. 14 is a diagram illustrating an example of a developing device including a sensor that detects a toner density.

### DETAILED DESCRIPTION

Hereinafter, an exemplary embodiment of the invention will be described in detail with reference to the accompanying drawings.

Descriptions of Overall Configuration of Image Forming Apparatus

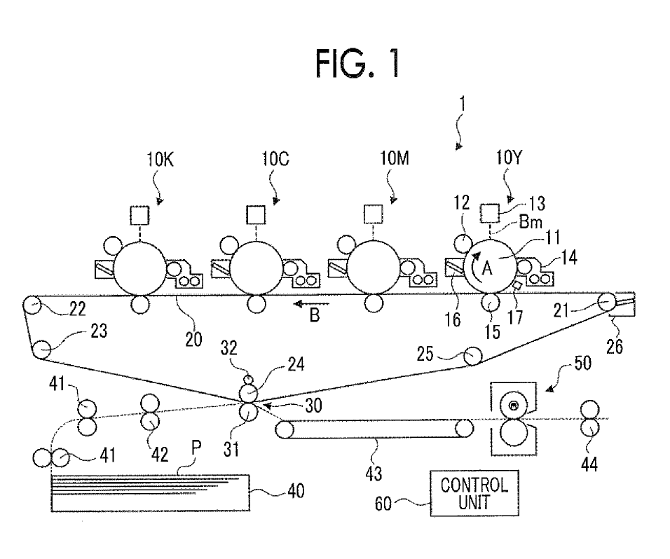

FIG. 1 is a diagram illustrating an outline of an image forming apparatus 1 according to the exemplary embodiment. The image forming apparatus 1 includes plural (4 in this exemplary embodiment) image forming units 10 (specifically, 10Y (yellow), 10M (magenta), 10C (cyan), and 10K (black)) which are an example of a toner image forming section, for example. The toner image forming section forms a toner image of each color component by using an electrophotographic process. The image forming apparatus 1 includes an intermediate transfer belt 20 that sequentially transfers (primarily transfers) color component toner images formed by the image forming units and holds the transferred images. The image forming apparatus 1 further includes a second transfer device 30 that collectively transfers (secondarily transfers) the toner images which have been transferred onto the intermediate transfer belt 20, onto paper (recording material) P. The image forming apparatus 1 further includes a fixing device 54 and a control unit 60. The fixing device 50 fixes the toner image which has been secondarily transferred, onto the paper P. The control unit 60 is an example of a control section that controls mechanisms of the image forming apparatus 1.

The image forming units 10 (10Y, 10M, 10C, and 10K) have the same configuration except for the color of the toner to be used. Thus, descriptions will be made by using the yellow image forming unit 10Y as an example. The yellow image forming unit 10Y includes a photosensitive drum 11. The photosensitive drum 11 includes a photoreceptive layer (not illustrated). The photosensitive drum 11 is arranged so as to be rotatable in a direction indicated by an arrow A, and holds an image. A charging roll 12, an exposure unit 13, a developing device 14, a primary transfer roll 15, and a drum cleaner 16 are arranged around the photosensitive drum 11. A density detection sensor 17 is disposed in the image forming unit 10Y. The density detection sensor 17 is disposed on a downstream side of the developing device 14 in a rotation direction of the photosensitive drum 11, so as to be adjacent to the developing device 14. The density detection sensor 17 reads a yellow toner image formed on the photosensitive drum 11 and detects density of the yellow toner image.

Among these components, the charging roll 12 is a rotation member that charges a surface of the photosensitive drum 11 and is disposed so as to contact with the photosensitive drum 11. The charging roll 12 is connected to a charging power source (not illustrated). The charging power source supplies a negative DC charging bias obtained by superimposing an AC charging bias of a predetermined frequency, to the charging roll 12.

The exposure unit 13 exposes the surface of the photosensitive drum 11, which is charged by the charging roll 12, so as to form an electrostatic latent image. The exposure unit 13 writes an electrostatic latent image on the photosensitive drum 11 charged by the charging roll 12, by using a laser beam Bm. The developing device 14 stores a toner of the corresponding color component (yellow toner in the yellow image forming unit 10Y), and develops an electrostatic latent image on the photosensitive drum 11 with the stored toner. A toner replenishing motor (not illustrated) is driven, and thus, the toner is supplied to the developing device 14 by a toner cartridge (not illustrated). The toner cartridge is an example of a toner storage section that stores a toner. The primary transfer roll 15 primarily transfers a toner image formed on the photosensitive drum 11 to the intermediate transfer belt 20. The drum cleaner 16 removes residual substances (toner and the like) on the photosensitive drum 11 after primary transfer. A developing bias supply (not illustrated) for applying a predetermined developing bias to the developing device 14 is connected to the developing device 14. A transfer bias supply (not illustrated) for applying a predetermined transfer bias to the primary transfer roll 15 is connected to the primary transfer roll 15.

The intermediate transfer belt 20 is stretched and supported by plural (5 in this exemplary embodiment) support rolls, so as to be rotatable. Among these support rolls, a driving roll 21 stretches the intermediate transfer belt 20 and drives the intermediate transfer belt 20 so as to be rotated in a direction indicated by an arrow B. A tension roll 22 and a tension roll 25 stretch the intermediate transfer belt 20 and are rotated by the intermediate transfer belt 20 which is driven by the driving roll 21. A correction roll 23 stretches the intermediate transfer belt 20 and functions as a steering roll which regulates belt walk in a direction perpendicular to the transporting direction of the intermediate transfer belt 20. The steering roll is arranged so as to be tiltable by using one end portion of the steering roll in an axis direction, as a fulcrum. A backup roll 24 stretches the intermediate transfer belt 20 and functions as a constituent member of the second transfer device 30 which will be described later.

A belt cleaner 26 is arranged at a part which faces the driving roll 21 with the intermediate transfer belt 20 interposed between the belt cleaner 26 and the driving roll 21. The belt cleaner 26 removes residual substances (toner and the like) on the intermediate transfer belt 20 after secondary transfer.

The second transfer device 30 includes a secondary transfer roll 31 and the backup roll 24. The secondary transfer roll 31 is disposed on a toner image holding surface side of the intermediate transfer belt 20 so as to be press-contacted. The backup roll 24 is disposed on a back surface side of the intermediate transfer belt 20 and functions as an electrode opposed to the secondary transfer roll 31. A feeding roll 32 is disposed so as to contact with the backup roll 24. The feeding roll 32 applies a secondary transfer bias of the same polarity as a charging polarity of the toner, to the backup roll 24. The secondary transfer roll 31 is grounded.

A paper transporting system includes a paper tray 40, a transport roller 41, a registration roll 42, a transport belt 43, and an exit roll 44. In the paper transporting system, paper P loaded in the paper tray 40 is transported by the transport roller 41, and then temporarily stopped at the registration roll 42. Then, the temporarily stopped paper is sent to a secondary transfer position of the second transfer device 30 at a predetermined timing. The paper P after secondary transfer is transported to the fixing device 50 using the transport belt 43. The paper P exiting from the fixing device 50 is sent to the outside of the apparatus by the exit roll 44.

Next, a basic image forming process of the image forming apparatus 1 will be described. If a start switch (not illustrated) is operated to be ON, a predetermined image forming process is performed. Specifically described, for example, when the image forming apparatus 1 is configured as a printer, digital image signals which are input from the outside (for example, a personal computer (PC) and the like) are temporarily accumulated in a memory. Toner images of the corresponding colors are relatively formed based on digital image signals of four colors (Y (yellow) color, M (magenta) color, C (cyan) color, and K (black) color) which are accumulated in the memory. That is, the image forming units (specifically, 10Y, 10M, 10C, and 10K) are respectively driven in accordance with the digital image signals of the corresponding colors. Then, in each of the image forming units 10, the photosensitive drum 11 charged by the charging roll 12 is irradiated with the laser beam Bm by the exposure unit 13, in accordance with the digital image signal, and thus an electrostatic latent image is formed. The developing device 14 develops the electrostatic latent image formed on the photosensitive drum 11 so as to form a toner image of the corresponding color. When the image forming apparatus 1 is configured as a copier, a scanner may read an original document set on a document stand (not illustrated) and the obtained read signal may be converted into a digital image signal by the processing circuit. Then, similar to the above descriptions, a toner image of each of the colors may be formed.

Then, toner images formed on photosensitive drums 11 are sequentially primarily transferred onto a surface of the intermediate transfer belt 20 at a primary transfer position at which the photosensitive drum 11 and the intermediate transfer belt 20 contact with each other, by the primary transfer roll 15. The toner remaining on the photosensitive drum 11 after the primary transfer is removed by the drum cleaner 16.

The toner images which have been primarily transferred to the intermediate transfer belt 20 in this manner are superimposed on the intermediate transfer belt 20. An image obtained by superimposition is transported to the secondary transfer position by rotating the intermediate transfer belt 20. The paper P is transported to the secondary transfer position at a predetermined timing and the paper P is nipped between the backup roll 24 and the secondary transfer roll 31.

The toner image held on the intermediate transfer belt 20 is secondarily transferred to the paper P at the secondary transfer position by an action of a transfer electric field formed between the secondary transfer roll 31 and the backup roll 24. The paper P to which the toner image is transferred is transported to the fixing device 50 by the transport belt 43. In the fixing device 50, the toner image on the paper P is fixed by heating and pressing. Then, the fixed image is sent to an exit tray (not illustrated) provided on the outside of the apparatus. The toner remaining on the intermediate transfer belt 20 after the secondary transfer is removed by the belt cleaner 26.

Description of Developer

Next, a developer containing a toner, which is used in this exemplary embodiment will be described in detail.

The developer used in this exemplary embodiment contains a carrier and a toner. The carrier is a magnetic material having magnetism. The magnetism is a non-magnetic material colored with yellow, magenta, cyan, or black. The developer contains a cleaning assist agent (assist agent). The cleaning assist agent reduces frictional force working between the photosensitive drum 11 (see FIG. 1) and the drum cleaner 16 (see FIG. 1) and suppresses friction of the photoreceptive layer provided in the photosensitive drum 11. The predetermined quantity of an external additive is added to the developer.

In the developer of this exemplary embodiment, for example, ferrite beads having an average particle diameter of about 35 μm are used as the carrier. As the cleaning assist agent, zinc stearate which is substantially colorless and transparent may be used. The zinc stearate has a charging polarity (positive polarity in this exemplary embodiment) reverse to that of the toner. The content of the cleaning assist agent in the developer is about 0.5%, for example. Inorganic fine particles of silica, titania, and the like are used as the external additive.

Description of Developing Device

Next, the developing device 14 will be described in detail.

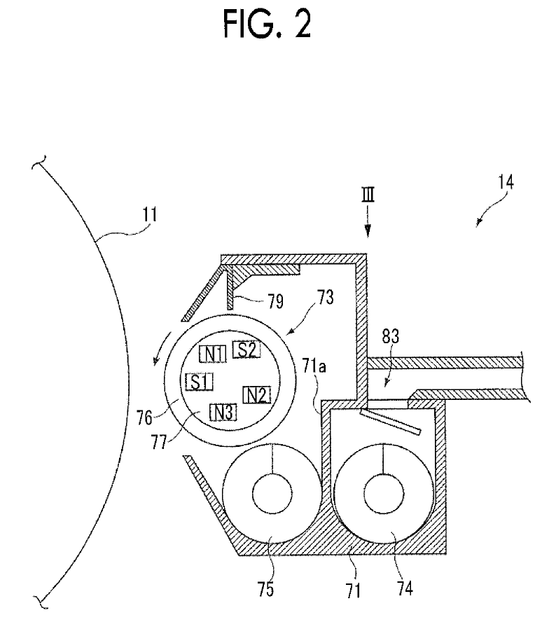

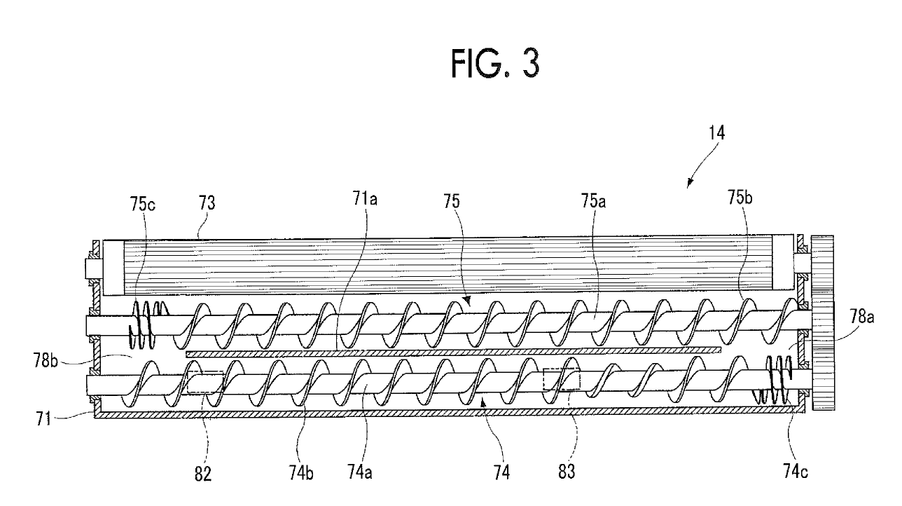

FIG. 2 illustrates a cross-sectional side view of the developing device 14. FIG. 3 illustrates a top view of the developing device 14 when FIG. 2 is viewed from a direction indicated by III.

The developing device 14 includes a developing housing 71 and a developing roll 73. The developing housing 71 has an opening portion (developing opening) facing the photosensitive drum 11 and stores the developer (not illustrated) which contains the toner and the carrier. The developing roll 73 is arranged at a location at which the developing roll 73 faces the opening portion of the developing housing 71 and is disposed so as to be rotated in a state of facing the photosensitive drum 11. The developing roll 73 develops an electrostatic latent image so as to form a toner image. A pair of screw augers 74 and 75 is provided on a lower side of the back surface of the developing roll 73 in the developing housing 71 when viewed from the photosensitive drum 11 side. The pair of screw augers 74 and 75 is arranged substantially parallel to an axial direction of the photosensitive drum 11 and transports the developer to the developing roll 73. In the following descriptions, the screw auger 74 on a side far from the developing roll 73 is referred to as a first screw auger 74, and the screw auger 75 on a side near to the developing roll 73 is referred to as a second screw auger 75. A partition wall 71a for performing partitioning into the first screw auger 74 and the second screw auger 75 is provided between the first screw auger 74 and the second screw auger 75. The partition wall 71a is integrally formed with the developing housing 71. A trimmer 79 is arranged on an upper side of the developing roll 73 at a predetermined distance from the developing roll 73. The trimmer 79 regulates the thickness of a developer layer on the developing roll 73.

Here, the developing roll 73 includes a developing sleeve 76 and a magnetic roll 77. The developing sleeve 76 is arranged so as to be rotatable. The magnetic roll 77 is arranged so as to be fixed to an inner side of the developing sleeve 76 and has plural magnetic poles arranged therein. The developing sleeve 76 is rotationally driven in a direction indicated by an arrow, by a motor (not illustrated) and is rotated at a developing position at which the developing sleeve 76 faces the photosensitive drum 11, in the same direction as the photosensitive drum 11. The developing sleeve 76 is formed of metal such as aluminum, for example. A developing bias supply (not illustrated) is connected to the developing sleeve 76. The developing bias supply applies a developing bias formed from a DC bias on which an AC bias is superimposed.

Five magnetic poles N1 to N3 and S1 to S2 are formed along an outer circumferential surface of the magnetic roll 77 in the magnetic roll 77. Here, the magnetic pole N2 (pickup pole) has a function of causing the developer which is agitated and transported by the second screw auger 75, to adhere to the developing sleeve 76. The magnetic pole S2 (trimming pole) has a function of forming a developer layer on an outer circumferential surface of the developing sleeve 76. The magnetic pole N1 (transport pole) transports the developer adhering to the developing sleeve 76 along with rotation of the developing sleeve 76. The magnetic pole S1 (developing pole) has a function of transporting the developer adhering to the developing sleeve 76 and forming grains of the developer in a developing area which faces the photosensitive drum 11. The magnetic pole N3 (pickoff pole) has a function of forming a repulsive magnetic field along with the adjacent magnetic pole N2 (pickup pole) and separating the developer which adheres to the developing sleeve 76 from the developing sleeve 76.

As illustrated in FIG. 3, the first screw auger 74 includes a rotation shaft 74a and a vane 74b, and transports the developer toward the right side of the drawing. The vane 74b is spirally attached to an outer circumference of the rotation shaft 74a. The second screw auger 75 also includes a rotation shaft 75a and a vane 75b, and transports the developer toward the left side in the drawing. The vane 75b is spirally attached to an outer circumference of the rotation shaft 75a. The rotation shaft 74a of the first screw auger 74 and the rotation shaft 75a of the second screw auger 75 are supported by the developing housing 71, so as to be rotatable. One end portion of each of the rotation shaft 74a and the rotation shaft 75a is disposed so as to protrude to an outside of the developing housing 71. The first screw auger 74 and the second screw auger 75 are rotationally driven by a driving mechanism (not illustrated).

The partition wall 71a is not provided on both end sides of the developing housing 71 in the axial direction thereof. Thus, communication ports 78 (specifically, 78a and 78b) are provided on both of the sides of the developing housing 71 in the axial direction thereof. The communication ports 78 are used for delivering the developer between the first screw auger 74 and the second screw auger 75. Here, a vane 74c is formed on a downstream side of the first screw auger 74 in a transporting direction of the developer, that is, on the communication port 78a side. The vane 74c has a pitch shorter than that of the vane 74b and a direction reverse to the vane 74b. The vane 74c causes the developer transported by the first screw auger 74 to be sent toward the communication port 78a. A vane 75c is formed on a downstream side of the second screw auger 75 in the transporting direction of the developer, that is, on the communication port 78b side. The vane 75c has a pitch shorter than that of the vane 75b and a direction reverse to the vane 75b. The vane 75c causes the developer transported by the second screw auger 75 to be sent toward the communication port 78b.

A developer replenishing port 82 is formed on the downstream side in the transporting direction of the developer. The developer replenishing port 82 is used for supplying a new developer into the developing device 14. The new developer is supplied from a developer bottle (not illustrated) which stores the developer.

A developer exit port 83 is formed on the downstream side of the developer replenishing port 82 in the transporting direction of the developer. The developer exit port 83 is used for causing the stale developer in the developing device 14 to exit to the outside of the developing device 14 at a constant rate.

Description of Operation of Developing Device

Next, a basic operation of the developing device 14 will be described.

The developer is circulated and transported along with agitation in the developing housing 71, by rotationally driving the first screw auger 74 and the second screw auger 75. This agitation operation causes the carrier and the toner constituting the developer to be rubbed to each other, and the toner is charged so as to have a negative polarity, by the friction. The carrier or the cleaning assist agent is charged so as to have a positive polarity, by the friction. If the developer which has been agitated and transported is transported to a portion facing the developing roll 73, a portion of the developer is transferred to the developing roll 73 by magnetic force of the magnetic pole N1 provided in the magnetic roll 77, and is transported along with rotation of the developing sleeve 76 which is rotationally driven.

When a developer layer transported by the developing sleeve 76 passes by the trimmer 79, the thickness of the developer layer is regulated so as to be a predetermined thickness, and the developer layer is carried to the opening portion of the developing housing 71, which faces the photosensitive drum 11, such that a predetermined transport amount thereof is transported. The developer which is not allowed to pass by the part of the trimmer 79 is caused to return into the developing housing 71 by the gravity.

A developing bias supply (not illustrated) is connected to the developing sleeve 76 which is on the surface of the developing roll 73. The developing bias supply causes the developing sleeve 76 to have a predetermined potential. The developing bias supply applies a predetermined developing bias. Thus, the toner in a developing area which is closest to the photosensitive drum 11 is transferred to a latent image formation area on the photosensitive drum 11 by the developer layer on the developing sleeve 76, and develops the electrostatic latent image so as to form a visible image. The obtained visible image corresponds to a toner image.

Then, the developer layer which passes through the opening portion of the developing housing 71 and is completely developed is transported in a state of being held on the developing sleeve 76. The developer layer on the developing sleeve 76 is separated from the developing roll 73 by a repulsive magnetic field, which is formed between the magnetic poles N3 and N2, and falls into the developing housing 71. The fallen developer layer is agitated and transported again by the first screw auger 74 and the second screw auger 75, and waits for the next developing process.

Because the toner is consumable, when the toner is insufficient, a density of an image to be formed is low and the image quality is deteriorated. Thus, in this case, it is necessary that an image forming operation is paused and a toner cartridge is replaced.

Recently, regarding an image forming apparatus, the size of the image forming apparatus is required to be reduced from a viewpoint of space saving. However, reduction of a distance between the image forming unit 10 and the toner cartridge may not be obtained due to restriction on a layout of the image forming unit 10 and the toner cartridge.

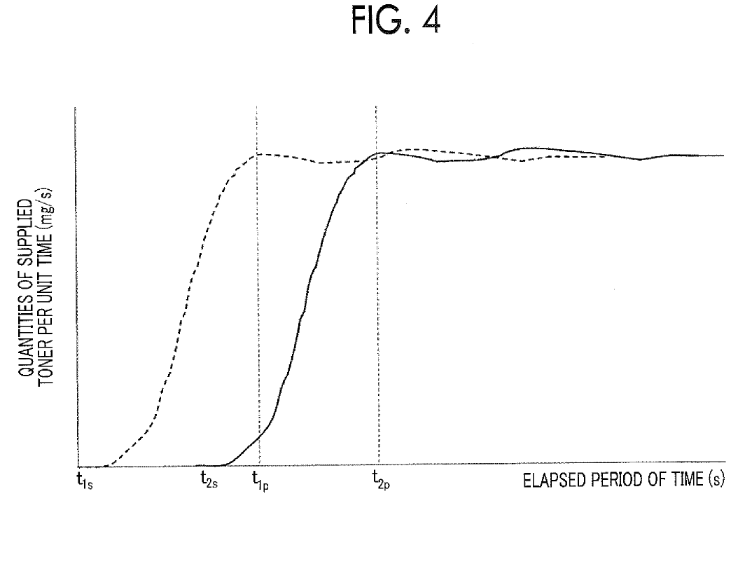

FIG. 4 is a diagram showing comparison between the quantities of a supplied toner per unit time in an image forming apparatus 1 and the quantities of a supplied toner per unit time in the other image forming apparatus 1. In the image forming apparatus 1, the toner cartridge is relatively close to the developing device 14 of the image forming unit 10. In the other image forming apparatus 1, the toner cartridge is relatively far from the developing device 14 of the image forming unit 10.

A horizontal axis in FIG. 4 indicates an elapsed period of time since the toner replenishing motor is driven to start a supply of the toner. A vertical axis in FIG. 4 indicates the quantity of the supplied toner per unit time. A dotted line indicates a case of the image forming apparatus 1 in which the toner cartridge is relatively close to the developing device 14 of the image forming unit 10. A solid line indicates a case of the image forming apparatus 1 in which the toner cartridge is relatively far from the developing device 14 of the image forming unit 10.

As illustrated in FIG. 4, when illustrated by the dotted line, a point of time at which a supply of the toner is started is set as a point t_{1S} of time. When illustrated by the solid line, a point of time at which a supply of the toner is started is set as a point t_{2S} of time. In this case, t_{1S}<t_{2S} is satisfied. Thus, the supply of the toner is started earlier in the case indicated by the dotted line, than in the case indicated by the solid line. A period of time until the quantity of supplied toner reaches a steady state where the quantity of the supplied toner is sufficient is set as a point t₁ₚ of time in the case indicated by the dotted line, and is set as a point t₂ₚ of time in the case indicated by the solid line. In this case, t₁ₚ<t₂ₚ is satisfied. Thus, the quantity of supplied toner reaches the steady state earlier in the case indicated by the dotted line, than in the case indicated by the solid line.

Accordingly, if the distance between the toner cartridge and the developing device 14 is farther, these points of time easily vary largely for each of the devices and toner cartridges of the image forming apparatus 1.

In order to satisfy various types of users' demands as other requirements, plural types of toner cartridges including one storing the large quantity of the toner and another storing the small quantity of the toner may be also prepared. If the configurations of the toner cartridge and the main body of the image forming apparatus 1 are changed for each of the requirements, cost is increased. Thus, it is desirable that the configuration of the main body of the image forming apparatus 1 is not changed and only the quantity of the stored toner is changed. At this time, if the quantity of the toner is set to be small, the period of time until the toner is supplied to the developing device 14 from the toner cartridge may be long.

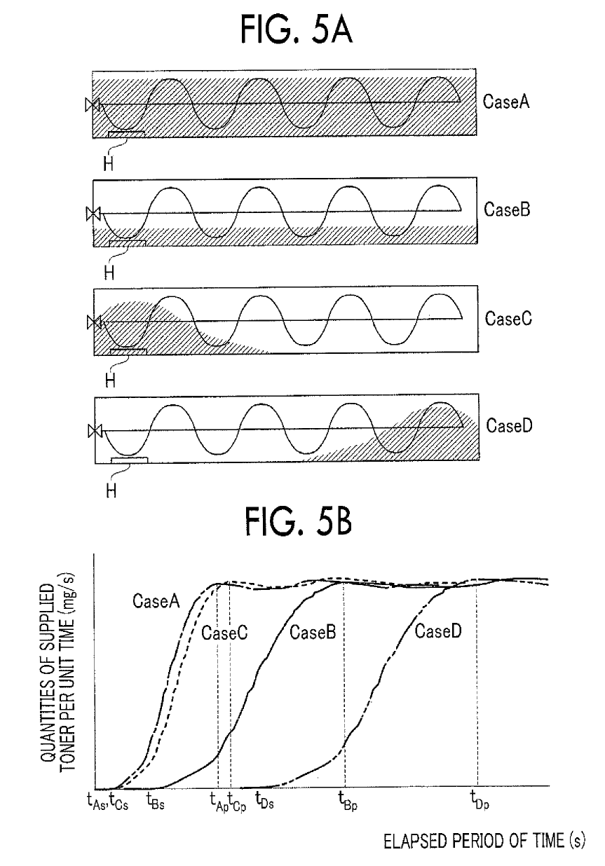

FIG. 5A is a diagram illustrating distribution of a toner in the toner cartridge when the quantity of the stored toner in the toner cartridge is relatively large and when the quantity of the stored toner is relatively small.

Case A indicates a case where the quantity of the stored toner in the toner cartridge is relatively large. In this case, the toner cartridge is substantially full of the toner, bias of the toner does not occur, and the toner is substantially uniformly distributed.

Case B to Case D indicate cases where the quantity of the stored toner in the toner cartridge is relatively small. Among these cases, Case B corresponds to a case where the bias of the toner in the toner cartridge does not occur, and the toner is substantially uniformly distributed. However, since the volume occupied by the toner in the toner cartridge is small, the bias of the toner may occur. Case C and Case D indicate such cases. Among these cases, Case C corresponds to a case where the toner in toner cartridge is gathered in the vicinity of an exit port H, and the bias of the toner occurs. Case D corresponds to a case where the toner in toner cartridge is gathered on an opposite side of the exit port H, and the bias of the toner occurs.

FIG. 5B is a diagram showing comparison of the quantities of the supplied toner per unit time in Case A to Case D, to each other.

A horizontal axis in FIG. 5B indicates an elapsed period of time from when the toner replenishing motor is driven to start a supply of the toner. A vertical axis in FIG. 5B indicates the quantity of the actually-supplied toner per unit time.

As illustrated in FIG. 5B, a period of time until the toner is supplied is the shortest in Case A and Case C (t_{As} in Case A and t_{Cs} in Case C), and is short in order of Case B (t_{Bs}) and Case D (t_{Ds}).

The cases are, in order of a period of time until the quantity of the supplied toner reaches the steady state where the quantity of the supplied toner is sufficient, Case A (t_{Ap}), Case C (t_{Cp}), Case B (t_{Bp}), and Case D (t_{Dp}). That is, if the quantity of the toner in the toner cartridge is small, the toner is biased in the toner cartridge, and these periods of time easily vary due to the inclination.

If a toner image is formed in the developing device 14 after the quantity of the supplied toner reaches the steady state where the quantity of the supplied toner is sufficient, in order to ensure appropriate image density, the longest period of time in the assumed cases is necessarily taken. Thus, a start of image formation performed by the image forming apparatus 1 is easily delayed longer in the case where the distance between the toner cartridge and the developing device 14 of the image forming unit 10 is relatively long, or the case where the quantity of the toner in the toner cartridge is set to be small. As a result, a user waiting period of time easily becomes longer.

Even when the quantity of the supplied toner is not sufficient, an image may be formed in some cases. This is a case where the toner for forming a toner image is insufficient, image density is low, image quality is deteriorated, but a user may allow such a situation. For example, this corresponds to a case where an operation of a user is urgent, and thus early reception of a printout has priority over image quality even when image density is low. For example, this corresponds to the following case. That is, when most of an image is configured by letters and the like, even when the image density is low, low image density is not observable. Thus, a user takes no notice.

In this exemplary embodiment, a user selects a time at which formation of an image is started, based on whether the user gives priority to ensuring of the image quality or to reducing of a period of time taken for waiting.

Description of Control Unit

The control unit 60 which performs the above descriptions will be described below.

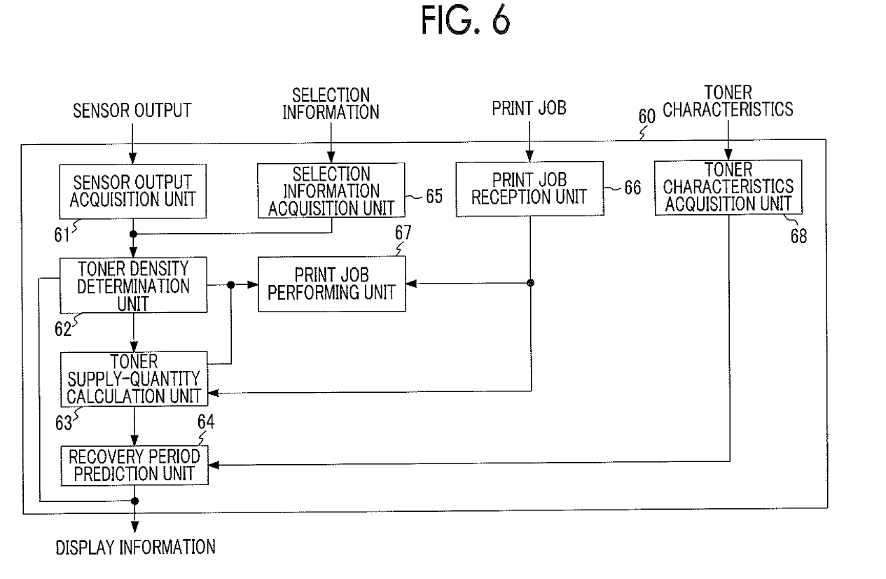

FIG. 6 is a block diagram illustrating a functional configuration example of the control unit 60.

FIG. 6 illustrates functions which are selected as functions relating to this exemplary embodiment, from various functions of the control unit 60.

As illustrated in FIG. 6, the control unit 60 includes a sensor output acquisition unit 61, a toner density determination unit 62, a toner supply-quantity calculation unit 63, a recovery period prediction unit 64, a selection information acquisition unit 65, a print job reception unit 66, a print job performing unit 67, and a toner characteristics acquisition unit 68. The sensor output acquisition unit 61 acquires a sensor output obtained from the density detection sensor 17. The toner density determination unit 62 determines a toner density based on the sensor output. The toner supply-quantity calculation unit 63 calculates the quantity of the supplied toner based on the determined toner density. The recovery period prediction unit 64 predicts a recovery period of time after replacement of a toner cartridge. The selection information acquisition unit 65 acquires information regarding selection, as selection information, when a user selects a condition regarding a timing at which formation of a toner image is started. The print job reception unit 66 receives a print job. The print job performing unit 67 causes a print job to be performed in the image forming apparatus 1. The toner characteristics acquisition unit 68 acquires information regarding toner characteristics.

The sensor output acquisition unit 61 acquires a sensor output which has been output from the density detection sensor 17 when the density detection sensor 17 reads a reference patch.

The reference patch corresponds to toner images created for each of the Y color, the M color, the C color, and the K color. The reference patch is created so as to have a setting density of, for example, 100%, 80%, 60%, 40%, and 20% for each of the Y color, the M color, the C color, and the K color. When the density detection sensor 17 reads the reference patch, the density detection sensor 17 outputs a sensor output in accordance with the toner density of the reference patch and the sensor output acquisition unit 61 acquires this sensor output.

The toner density determination unit 62 calculates a toner density based on the acquired sensor output, and determines whether or not the calculated toner density is smaller than a control range. When the toner density is smaller than the control range, it is determined that there is no toner, and a print operation of the print job performing unit 67 is stopped. The toner density determination unit 62 outputs a message indicating that there is no toner, or a message for prompting a user to replace a toner cartridge, as display information. This message is displayed on a user interface (UI) of the image forming apparatus 1, for example. The UI is an example of a display section and is configured by a touch panel.

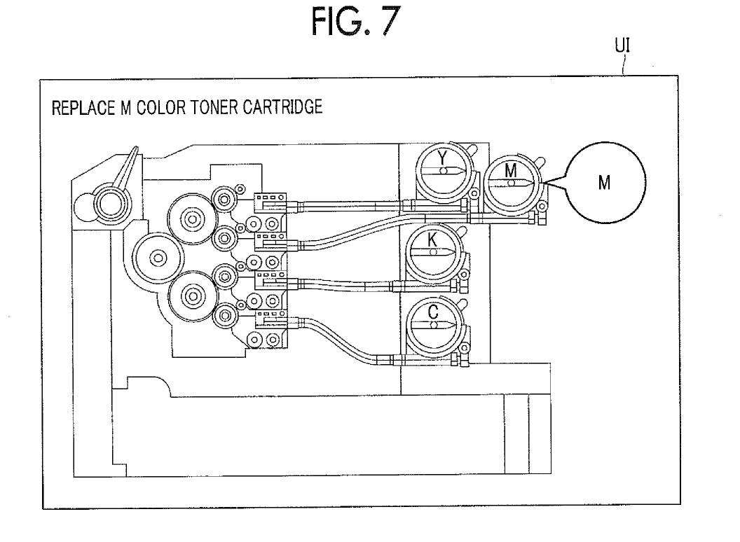

FIG. 7 is a diagram illustrating an example of a screen displayed on the UI when there is no toner.

The example illustrated in FIG. 7 corresponds to a case where there is no M color toner. In this case, a message indicating that “Replace an M color toner cartridge” and a position of the M color toner cartridge in the image forming apparatus 1 are displayed.

After a toner cartridge is replaced, the toner density determination unit 62 determines a timing at which formation of a toner image is started, based on selection information acquired by the selection information acquisition unit 65. The print job performing unit 67 starts formation of an image based on this determination. This situation will be described later. When formation of an image is started, the toner density determination unit 62 outputs display information for releasing the message indicating that there is no toner.

The toner supply-quantity calculation unit 63 calculates the quantity of the supplied toner, based on the toner density calculated by the toner density determination unit 62. The print job performing unit 67 performs formation of an image by supplying the calculated quantity of the toner.

After there is no toner and a toner cartridge is replaced, the recovery period prediction unit 64 is an example of a prediction section that predicts a period of time until the quantity of the supplied toner to the image forming unit 10 is sufficient. This period of time is a period of time (as illustrated in FIG. 4) until the quantity of the supplied toner reaches the steady state. This period of time may be referred to as a period of time until the quantity of the supplied toner causes a state to return to a general state. Here, this period of time may be referred to as “a recovery period of time” below. The recovery period prediction unit 64 outputs a recovery period of time as display information.

Although described below in detail, the recovery period prediction unit 64 predicts the recovery period of time based on information regarding toner characteristics, and a relationship between (i) a period of time until a supply of the toner to the image forming unit 10 is started and (ii) the quantity of the supplied toner.

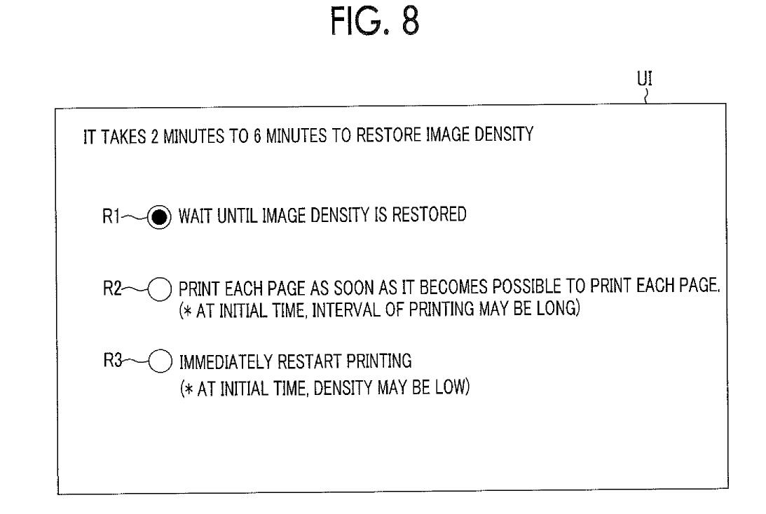

FIG. 8 is a diagram illustrating an example of a screen displayed on the UI after the toner cartridge is replaced.

In the example illustrated in FIG. 8, a message indicating that “it takes 2 minutes to 6 minutes to restore image density” is displayed for a user. This “2 minutes to 6 minutes” corresponds to the above-described recovery period of time. Radio buttons R1 to R3 for allowing a user to select a condition regarding a timing at which formation of a toner image starts are displayed on this screen.

A case where the user selects the radio button R1 which corresponds to a case where “wait until image density is restored” means that the user selects to wait for a period of time of 2 minutes to 6 minutes until the image density is restored.

A case where the user selects the radio button R2 which corresponds to a case where “print each page as soon as it becomes possible to print each page (*at an initial time, an interval of printing may be long)” means that the user selects a case where formation of a toner image is started if the quantity of the toner used in the image forming unit 10 is sufficient from a viewpoint of the relationship with the image density even though the quantity of the supplied toner is not sufficient, which will be described below in detail.

A case where the user selects the radio button R3 which corresponds to a case where “immediately restart printing (*at an initial time, the density may be low)” means that the user selects a case where formation of a toner image is started if a supply of the toner to the image forming unit 10 is started even though the quantity of the supplied toner is not sufficient. At this time, since the quantity of the supplied toner is insufficient for a while after an image is formed, a message indicating that “(*at an initial time, the density may be low)” is displayed.

In this case, the UI may be recognized as the selection section that allows a user to select the condition regarding a time at which formation of a toner image in the image forming unit 10 is started, after a toner cartridge which stores the toner is replaced.

The selection information acquisition unit 65 acquires information of selection on the screen illustrated in FIG. 8, as selection information, when the user selects the condition regarding a timing at which formation of a toner image is started.

The print job reception unit 66 receives a print job which has been transmitted from a user. The print job is one data group transmitted along with a print instruction from a user. The print job includes the contents of an image to be printed; the contents of the number of printed sheets, which means the number of pages and the number of printouts; the contents of a print status which means how many pages is printed on one sheet of paper or whether one-sided print or double-sided print is performed; and the like. The print job reception unit 66 receives the print job through a network, for example. Examples of the network include a local area network (LAN) and the Internet.

The print job performing unit 67 operates the mechanism units of the image forming apparatus 1, and thus performs a print job and performs printing on paper.

The print job performing unit 67 starts formation of an image in accordance with the selection information acquired by the selection information acquisition unit 65. Thus, the print job performing unit 67 may be recognized as a performing unit that performs formation of a toner image of the image forming unit 10 in accordance with the selection information.

The toner characteristics acquisition unit 68 is an example of a toner characteristic acquisition unit that acquires information regarding the toner characteristics.

Here, the information regarding the toner characteristics corresponds to a ratio of the volume of the toner to capacity of the toner cartridge, and date when the toner is stored in the toner cartridge.

Description of Prediction of Recovery Period of Time

Next, a method of causing the recovery period prediction unit 64 to predict the recovery period of time will be described.

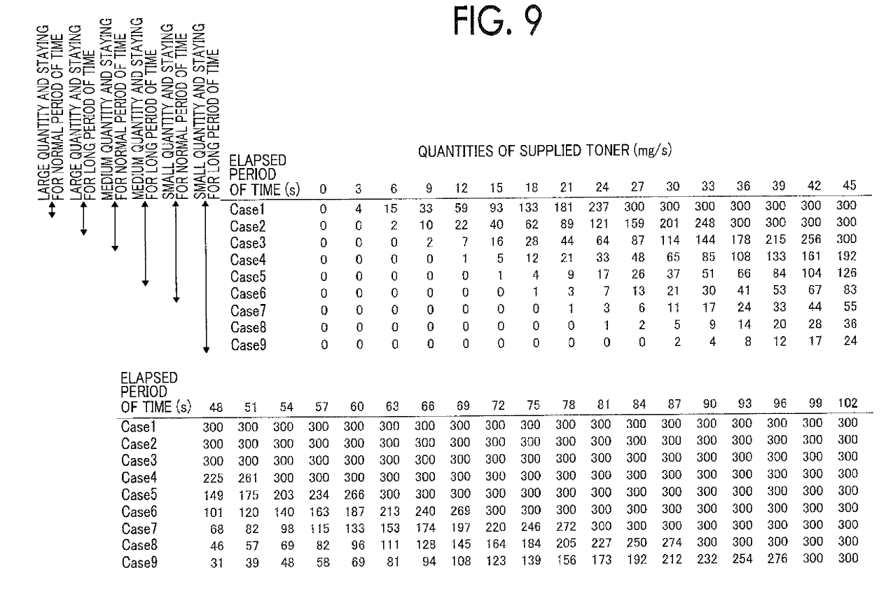

FIG. 9 is a diagram illustrating a relationship, after the toner cartridge is replaced, between an elapsed time from a start of a supply of the toner and the quantity of the supplied toner.

Here, a period of time from when a supply of the toner is started until the toner is actually supplied increases from Case 1 to Case 9. A period of time (recovery period of time) until the quantity of the supplied toner reaches the steady state increases from Case 1 to Case 9. Here, the quantity of the supplied toner in the normal state is 300 mg/s.

A case where the ratio of the volume of the toner to the capacity of the toner cartridge and the date when the toner is stored in the toner cartridge are used as the information regarding the toner characteristics is considered. In this case, a case where the ratio of the volume of the toner to the capacity of the toner cartridge is relatively large is set as “large quantity”, a case where the ratio is moderate is set as “medium quantity”, and a case where the ratio is relatively small is set as “small quantity”. In addition, a case where the number of elapsed days from the date when the toner is stored in the toner cartridge is not large is set as “staying for a normal period of time” and a case where the number of elapsed days is large is set as “staying for a long period of time”. As a result, the toner characteristics may be classified into 6 types, that is, “large quantity and staying for a normal period of time”, “large quantity and staying for a long period of time”, “medium quantity and staying for a normal period of time”, “medium quantity and staying for a long period of time”, “small quantity and staying for a normal period of time”, and “small quantity and staying for a long period of time”.

In this state, each of the six types of toner characteristics is actually measured so as to determine a case to which each of the six types of toner characteristics may be applied among Case 1 to Case 9. First, similarly to Case A in FIG. 5A, Case 1 may be applied to “large quantity and staying for a normal period of time”. Similarly to Case B to Case D, the bias of the toner in the toner cartridge may occur in a case of “small quantity and staying for a normal period of time”. As a result, a period of time until the toner is actually supplied or a period of time (recovery period of time) until the quantity of the supplied toner reaches the steady state varies. Thus, in this case, Case 1 to Case 6 may be applied. Since “medium quantity and staying for a normal period of time” is positioned between “large quantity and staying for a normal period of time” and “small quantity and staying for a normal period of time”, Case 1 to Case 3 may be applied.

In a case of “staying for a long period of time”, toner particles are easily aggregated and thus the period of time until the toner is actually supplied or the period of time (recovery period of time) until the quantity of the supplied toner reaches the steady state easily increases in comparison to a case of “staying for a normal period of time”. As a result, Case 1 to Case 2 are applied to “large quantity and staying for a long period of time”, Case 1 to Case 5 are applied to “medium quantity and staying for a long period of time”, and Case 1 to Case 9 are applied to “small quantity and staying for a long period of time”.

Accordingly, since a case which may be applied among Case 1 to Case 9 in accordance with the toner characteristics is confirmed, the recovery period of time may be predicted by using the confirmed case.

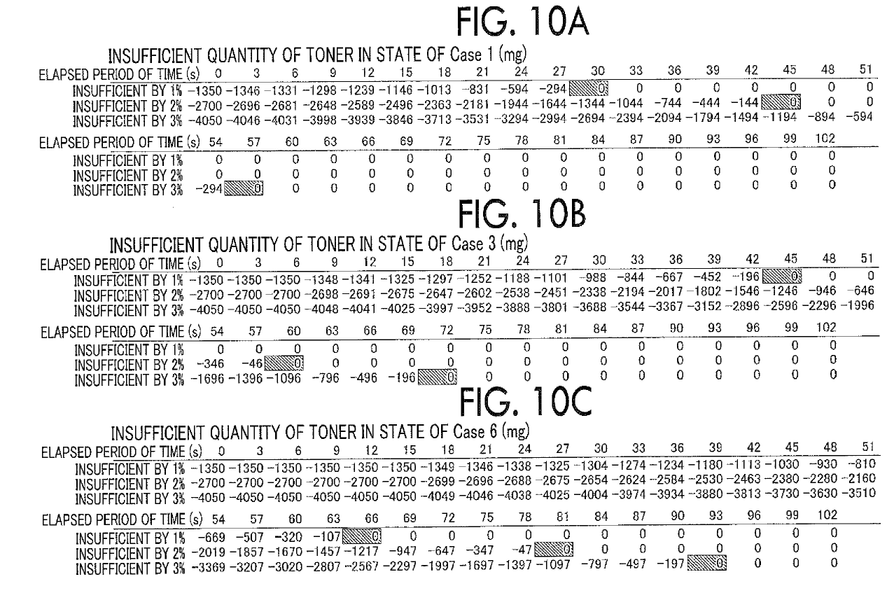

FIGS. 10A to 10C illustrate examples in which the recovery period of time is actually predicted.

Among these drawings, FIG. 10A illustrates an example in which the recovery period of time is respectively predicted when the toner density calculated by the toner density determination unit 62 is insufficient by 1%, 2%, and 3% in Case 1. It is assumed that the insufficient quantity of the toner when the toner density is insufficient by 1% is set to 1350 mg. Similarly, it is assumed that the insufficient quantity of the toner when the toner density is insufficient by 2% is set to 2700 mg, and it is assumed that the insufficient quantity of the toner when the toner density is insufficient by 3% is set to 4050 mg. FIG. 10A illustrates these cases which are respectively set to “−1350”, “−2700”, and “−4050”.

When the toner density is insufficient by 1%, 4 mg of the toner is supplied after 3 seconds from a start of a supply of the toner, if referring to Case 1 in FIG. 9. Thus, the insufficient quantity of the toner at this point of time satisfies 1350 mg-4 mg, that is, 1346 mg. 15 mg of the toner is supplied after 6 seconds from the start of a supply of the toner. Thus, the insufficient quantity of the toner at this point of time satisfies 1346 mg-15 mg, that is, 1331 mg. If the insufficient quantity of the toner is calculated for each period of time in this manner, the insufficient quantity of the toner after 30 seconds from the start of a supply of the toner is 0. That is, in this case, the recovery period of time may be predicted to be 30 seconds.

Similarly, it may be predicted that the recovery period of time is 45 seconds when the toner density is insufficient by 2%, and the recovery period of time is 57 seconds when the toner density is insufficient by 3%.

FIG. 10B illustrates an example in which the recovery period of time is respectively predicted when the toner density calculated by the toner density determination unit 62 is insufficient by 1%, 2%, and 3% in Case 3.

In this case, a prediction method of the recovery period of time is also similarly to that in FIG. 10A. Thus, it may be predicted that the recovery period of time is 45 seconds when the toner density is insufficient by 1% in Case 3. In addition, it may be predicted that the recovery period of time is 60 seconds when the toner density is insufficient by 2%, and the recovery period of time is 72 seconds when the toner density is insufficient by 3%.

FIG. 10C illustrates an example in which the recovery period of time is respectively predicted when the toner density calculated by the toner density determination unit 62 is insufficient by 1%, 2%, and 3% in Case 6.

It may be predicted that the recovery period of time is 66 seconds when the toner density is insufficient by 1% in Case 6. In addition, it may be predicted that the recovery period of time is 81 seconds when the toner density is insufficient by 2%, and the recovery period of time is 93 seconds when the toner density is insufficient by 3%.

The length of the recovery period of time is confirmed based on a case which may be applied among Case 1 to Case 9. For example, when the toner characteristics correspond to “large quantity and staying for a normal period of time”, Case 1 is applied. The recovery period of time when the toner density is insufficient by 1% is 30 seconds. In a case of “medium quantity and staying for a normal period of time”, Case 1 to Case 3 are applied and the recovery period of time when the toner density is insufficient by 1% is from 30 seconds to 45 seconds. In a case of “small quantity and staying for a normal period of time”, Case 1 to Case 6 are applied and the recovery period of time when the toner density is insufficient by 1% is from 30 seconds to 66 seconds.

In this manner, the recovery period prediction unit 64 predicts the recovery period of time based on the information regarding toner characteristics, and the relationship between (i) the period of time until a supply of the toner to the image forming unit 10 is started and (ii) the quantity of the supplied toner. In the above-described examples, the recovery period prediction unit 64 predicts the recovery period of time based further on the insufficient quantity of the toner density.

Description of Processing in Case where “Print Each Page as Soon as it Becomes Possible to Print Each Page”

Next, processing when the radio button R2 is selected on the screen in FIG. 8 will be described. The radio button R2 corresponds to a case where “print each page as soon as it becomes possible to print each page (*at an initial time, an interval of printing may be long)”.

In this case, formation of a toner image is started if the quantity of the toner used in the image forming unit 10 is sufficient from the viewpoint of the relationship with the image density even though the quantity of the supplied toner is not sufficient. That is, since the quantity of the supplied toner is sufficient if an image density of an image is small even before it is the recovery period of time, an image may not be pale. Thus, at this time, formation of an image is started under a condition which means that a user selects the radio button R2.

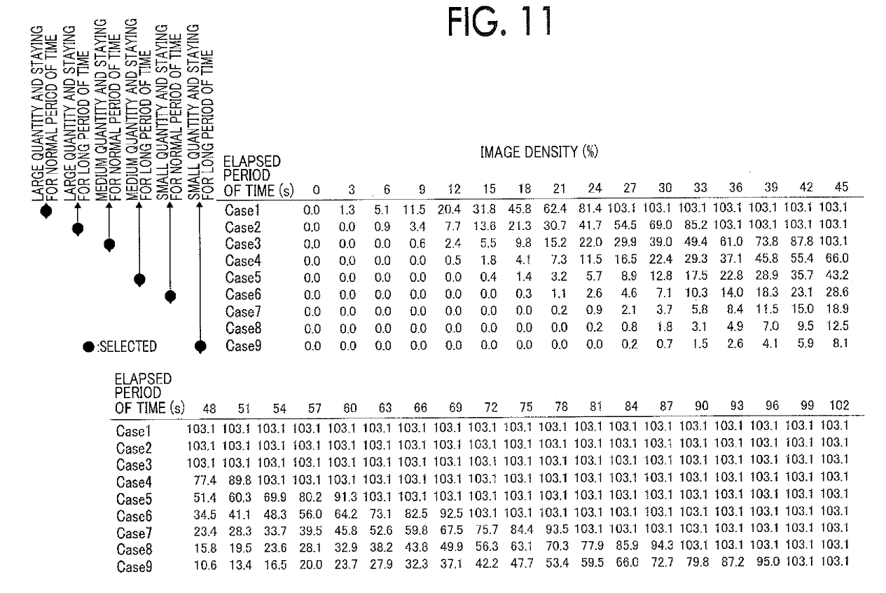

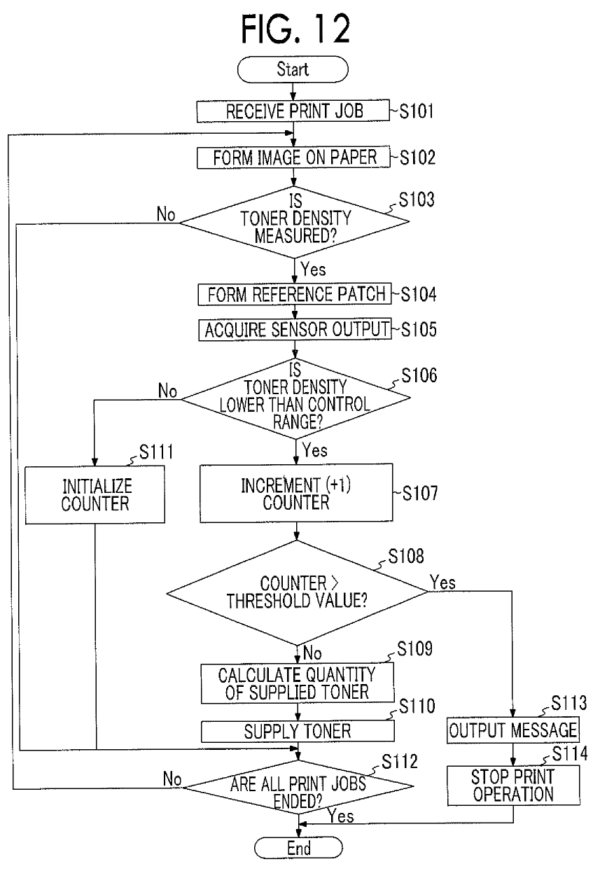

FIG. 11 is a diagram illustrating a relationship, after the toner cartridge is replaced, between the elapsed time from a start of a supply of the toner and an image density allowing a start of image formation.

The image density illustrated in FIG. 11 corresponds to summation of ratios of areas of images of the colors (yellow, magenta, cyan, and black) to an area of paper P when the paper P having a size of A4 is used.

At this time, a case of the smallest quantity of the supplied toner is selected among Case 1 to Case 9 which are applied in accordance with the toner characteristics. For example, when the toner characteristics correspond to “medium quantity and staying for a normal period of time”, Case 1 to Case 3 are applied. However, in this case, Case 3 is selected. When the toner characteristics correspond to “small quantity and staying for a long period of time”, Case 1 to Case 9 are applied. However, in this case, Case 9 is selected.

That is, as described above, the period of time until the toner is supplied varies depending on the toner characteristics. However, a pattern in which a supply of the toner is delayed longest is selected.

Formation of an image is started in accordance with the selected case, after an elapsed period of time when image density of an image to be printed next will be equal to or lower than the image density illustrated. When formation of an image is once started, but an image density of an image to be printed next is higher, there may be a case where forming of a next image is halted until the above condition is satisfied. This situation may occur at an initial time when formation of an image is started and does not occur after the recovery period of time elapses. Thus, the message indicating “(*at an initial time, an interval of printing may be long)” is displayed on the screen of FIG. 8.

Description of Operation of Control Unit

Next, an operation of the control unit 60 will be described. Here, descriptions will be made in a state where the operation of the control unit 60 is classified into a normal operation when an image is normally formed, and a recovery operation after a toner cartridge is replaced.

FIG. 12 is a flowchart illustrating the normal operation of the control unit 60.

First, the print job reception unit 66 receives a print job (Step 101).

Then, the print job performing unit 67 performs the received print job and forms an image on paper P (Step 102).

After the print job performing unit 67 ends each of print jobs, the print job performing unit 67 determines whether or not a toner density is measured (Step 103). For example, the toner density is periodically measured when the number of printed sheets is equal to or greater than a predetermined value after the toner density is previously measured or when a predetermined period of time elapses after the toner density is previously measured.

When the print job performing unit 67 determines that the toner density is not measured (No in Step 103), the process proceeds to Step 112.

When the print job performing unit 67 determines that the toner density is measured (Yes in Step 103), the print job performing unit 67 causes the image forming unit 10 to form a reference patch (Step 104).

The sensor output acquisition unit 61 acquires a sensor output when the density detection sensor 17 reads the reference patch (Step 105).

Then, the toner density determination unit 62 calculates a toner density of the reference patch based on the sensor output and determines whether or not the toner density is lower than the control range (Step 106).

When the toner density is lower than the control range (Yes in Step 106), the toner density determination unit 62 increments a counter (+1) (Step 107).

The toner density determination unit 62 determines whether or not a value of the counter is greater than a threshold value (Step 108).

At this time, when the value of the counter is not greater than the threshold value (No in Step 108), the toner supply-quantity calculation unit 63 calculates the quantity of the supplied toner based on the toner density (Step 109). This quantity of the supplied toner may be obtained by using the following expression (1), for example.

(Quantity of the supplied toner)=(the current toner density)−(target value of the toner density)×(coefficient 1) (1)

The print job reception unit 66 supplies the toner of the quantity of the supplied toner which is calculated by the toner supply-quantity calculation unit 63 (Step 110).

When the toner density is within the control range (No in Step 106), the toner density determination unit 62 initializes the counter (Step 111).

After the process of Step 110 and after the process of Step 111, the print job reception unit 66 determines whether or not all print jobs are ended (Step 112).

When all of the print jobs are not ended (No in Step 112), the process returns to Step 102. When the all of the print jobs are ended (Yes in Step 112), the process is ended.

When the value of the counter is greater than the threshold value (Yes in Step 108), the toner density determination unit 62 outputs a message indicating that there is no toner or a message for prompting a user to replace a toner cartridge, as display information to the UI (Step 113). At this time, the screen illustrated in FIG. 7 is displayed in the UI.

The toner density determination unit 62 stops the print operation of the print job performing unit 67 (Step 114).

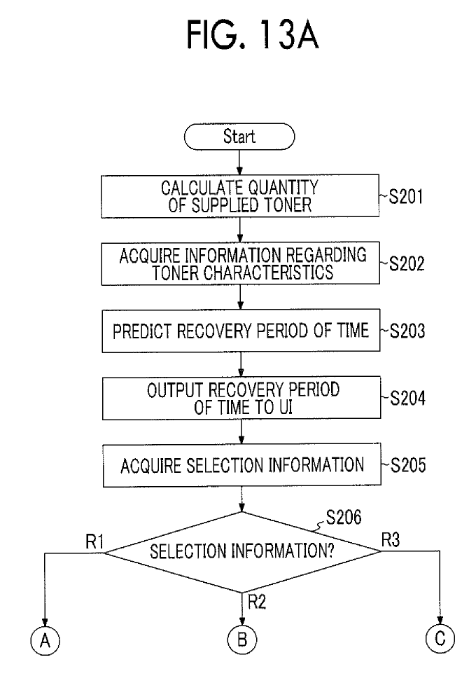

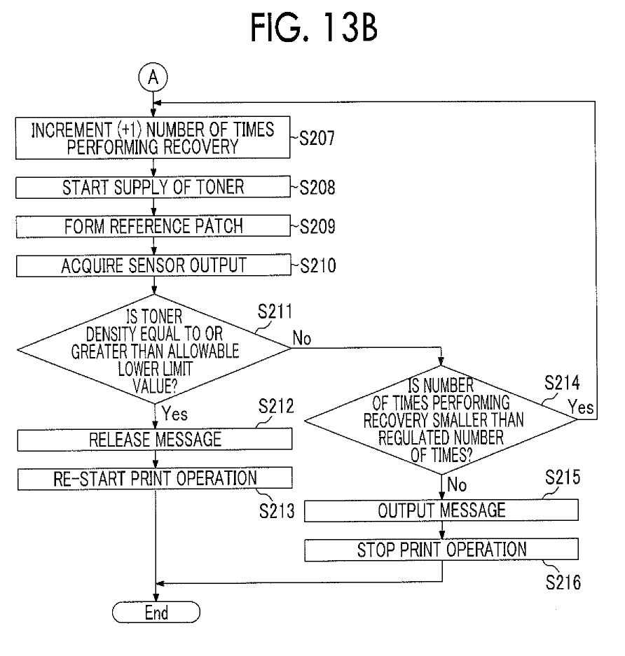

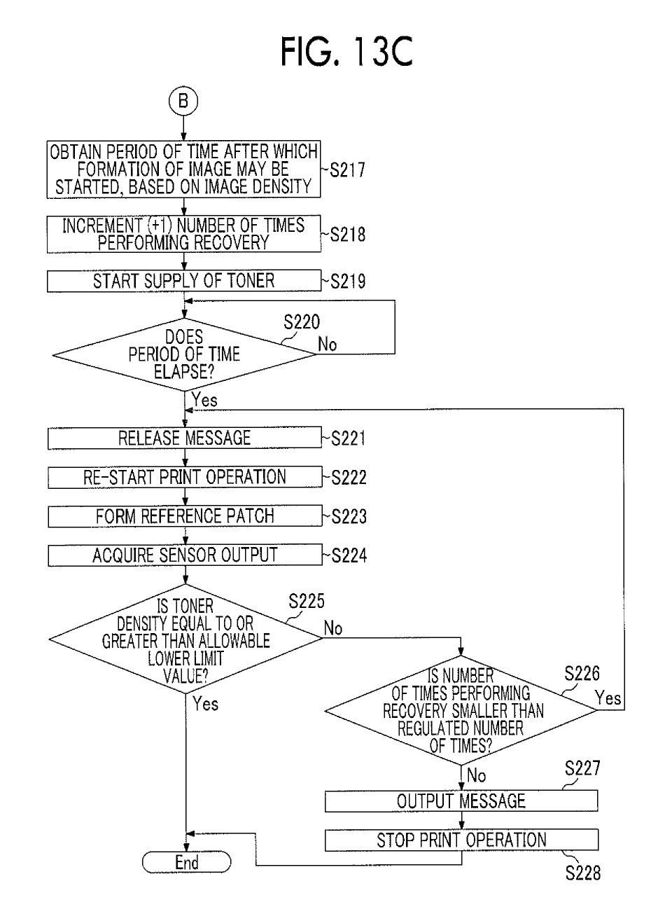

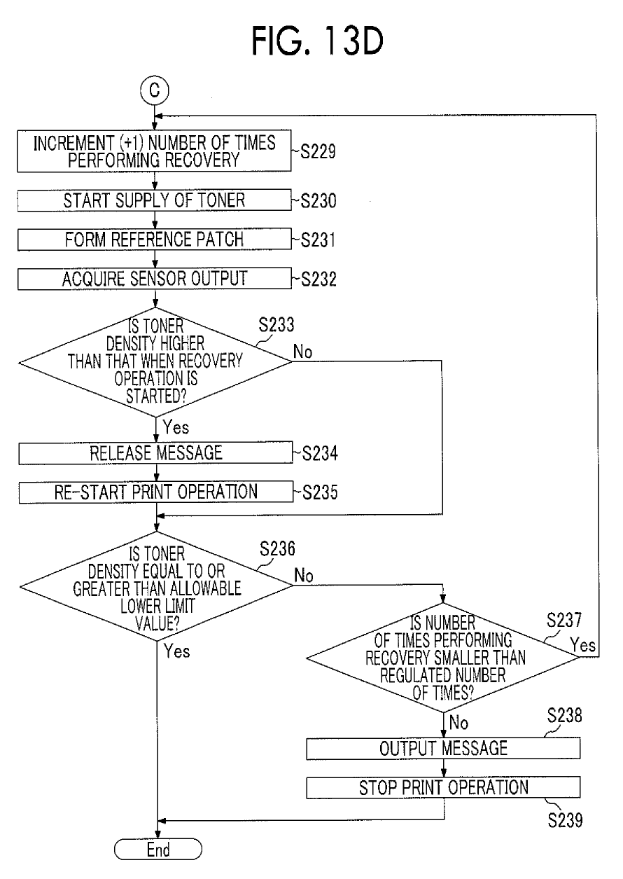

FIGS. 13A to 13D are flowcharts illustrating the recovery operation of the control unit 60.

When a toner cartridge is replaced, first, the toner supply-quantity calculation unit 63 calculates the quantity of the supplied toner based on the toner density when the processes of Step 109 to Step 110 are performed (Step 201). This quantity of the supplied toner may be obtained by using the following expression (2), for example.

(Quantity of the supplied toner)=(the current toner density)−(target value of the toner density)×(coefficient 2) (2)

Then, the toner characteristics acquisition unit 68 acquires information regarding the toner characteristics (Step 202). This is performed as follows, for example. That is, a memory for storing toner information may be provided in the toner cartridge and this information may be read from the provided memory.

The recovery period prediction unit 64 predicts the recovery period of time by using the method illustrated in FIGS. 9 to 10C (Step 203). The recovery period prediction unit 64 outputs the recovery period of time as display information to the UI (Step 204). At this time, the screen illustrated in FIG. 8 is displayed in the UI.

If a user selects any of the radio buttons R1 to R3 on the screen in FIG. 8, the selection information acquisition unit 65 acquires information of selection as selection information (Step 205).

At this time, the following process is performed in accordance with the button selected among the radio buttons R1 to R3 by the user.

Case where User Selects Radio Button R1

When the user selects the radio button R1 which corresponds to a case where “wait until the image density is restored” (R1 in Step 206), the number of times performing recovery is incremented (+1) (Step 207).

The print job reception unit 66 starts a supply of the toner based on the quantity of the supplied toner which is calculated by the toner supply-quantity calculation unit 63 (Step 208).

Then, the print job performing unit 67 causes the image forming unit 10 to form the reference patch (Step 209).

The sensor output acquisition unit 61 acquires a sensor output when the density detection sensor 17 reads the reference patch (Step 210).

Then, the toner density determination unit 62 calculates a toner density of the reference patch based on the sensor output and determines whether or not the calculated toner density is equal to or greater than an allowable lower limit value (Step 211).

When the toner density is equal to or greater than the allowable lower limit value (Yes in Step 211), the toner density determination unit 62 outputs display information for releasing the message which indicates that there is no toner (Step 212).

The toner density determination unit 62 re-starts the print operation of the print job performing unit 67 (Step 213).

When the toner density is not equal to or greater than the allowable lower limit value (No in Step 211), the toner density determination unit 62 determines whether or not the number of times performing recovery is smaller than a regulated number of times (Step 214).

When the number of times performing recovery is smaller than regulated number of times (Yes in Step 214), the process returns to Step 207. When the number of times performing recovery is equal to or greater than the regulated number of times (No in Step 214), the toner density determination unit 62 outputs the message indicating that there is no toner, or the message for prompting a user to replace a toner cartridge, as display information to the UI again (Step 215). At this time, the screen illustrated in FIG. 7 is displayed in the UI.

The toner density determination unit 62 stops the print operation of the print job performing unit 67 (Step 216).

Case where User Selects Radio Button R2

When the user selects the radio button R2 which corresponds to a case where “print each page as soon as it becomes possible to print each page (*at an initial time, an interval of printing may be long)”, on the screen in FIG. 8 (R2 in Step 206), as illustrated in FIG. 11, the toner density determination unit 62 obtains a period of time after which formation of an image may be started, based on the toner characteristics and image density of an image to be printed next (Step 217).

Then, the number of times performing recovery is incremented (+1) (Step 218).

The print job reception unit 66 starts a supply of the toner based on the quantity of the supplied toner which is calculated by the toner supply-quantity calculation unit 63 (Step 219).

Then, the toner density determination unit 62 determines whether or not the period of time after which formation of an image may be started elapses (Step 220).

When the period of time does not elapse (No in Step 220), the process returns to Step 220.

When the period of time elapses (Yes in Step 220), the toner density determination unit 62 outputs display information for releasing the message indicating that there is no toner. (Step 221).

The toner density determination unit 62 re-starts the print operation of the print job performing unit 67 (Step 222).

Then, the print job performing unit 67 causes the image forming unit 10 to form a reference patch (Step 223).

The sensor output acquisition unit 61 acquires a sensor output when the density detection sensor 17 reads the reference patch (Step 224).

Then, the toner density determination unit 62 calculates a toner density of the reference patch based on the sensor output and determines whether or not the toner density is equal to or greater than the allowable lower limit value (Step 225).

When the toner density is equal to or greater than the allowable lower limit value (Yes in Step 225), the process is ended.

When the toner density is not equal to or greater than the allowable lower limit value (No in Step 225), the toner density determination unit 62 determines whether or not the number of times performing recovery is smaller than the regulated number of times (Step 226).

When the number of times performing recovery is smaller than regulated number of times (Yes in Step 226), the process returns to Step 219. When the number of times performing recovery is equal to or greater than the regulated number of times (No in Step 226), the toner density determination unit 62 outputs the message indicating that there is no toner, or the message for prompting a user to replace a toner cartridge, as display information to the UI again (Step 227). At this time, the screen illustrated in FIG. 7 is displayed in the UI.

The toner density determination unit 62 stops the print operation of the print job performing unit 67 (Step 228).

Case Where User Selects Radio Button R3 When the user selects the radio button R3 which corresponds to a case where “immediately restart printing (*at an initial time, the density may be low)”, on the screen in FIG. 8 (R3 in Step 206), the number of times performing recovery is incremented (+1) (Step 229).

The print job reception unit 66 starts a supply of the toner based on the quantity of the supplied toner which is calculated by the toner supply-quantity calculation unit 63 (Step 230).

Then, the print job performing unit 67 causes the image forming unit 10 to form the reference patch (Step 231).

The sensor output acquisition unit 61 acquires a sensor output when the density detection sensor 17 reads the reference patch (Step 232).

Then, the toner density determination unit 62 calculates a toner density of the reference patch based on the sensor output and determines whether or not the calculated toner density is higher than that when the recovery operation is started (Step 233). This means that a supply of the toner to the image forming unit 10 is started.

When the toner density is higher than that when the recovery operation is started (Yes in Step 233), the toner density determination unit 62 outputs display information for releasing the message which indicates that there is no toner (Step 234).

The toner density determination unit 62 re-starts the print operation of the print job performing unit 67 (Step 235).

When the toner density is not higher than that when the recovery operation is started (No in Step 233), and after the process of Step 235, the toner density determination unit 62 determines whether or not the toner density is equal to or greater than the allowable lower limit value (Step 236).

When the toner density is equal to or greater than the allowable lower limit value (Yes in Step 236), the process is ended.

When the toner density is not equal to or greater than the allowable lower limit value (No in Step 236), the toner density determination unit 62 determines whether or not the number of times performing recovery is smaller than a regulated number of times (Step 237).

When the number of times performing recovery is smaller than regulated number of times (Yes in Step 237), the process returns to Step 229. When the number of times performing recovery is equal to or greater than the regulated number of times (No in Step 237), the toner density determination unit 62 outputs the message indicating that there is no toner, or the message for prompting a user to replace a toner cartridge, as display information to the UI again (Step 238). At this time, the screen illustrated in FIG. 7 is displayed in the UI.

The toner density determination unit 62 stops the print operation of the print job performing unit 67 (Step 239).

According to the above-described image forming apparatus 1, a time at which formation of an image is started may be selected in accordance with a request of a user. At this time, the recovery period of time predicted considering the toner characteristics is displayed for the user, and thus the user may obtain important determination information in a state where the time at which formation of an image is started is selected. When the radio button R2 which corresponds to the case where “print each page as soon as it becomes possible to print each page (*at an initial time, an interval of printing may be long)” is selected on the screen in FIG. 8, the toner density is less likely low even though formation of an image is started in a state where the quantity of the supplied toner is not restored. As a result, the image quality is less likely deteriorated. Thus, formation of an image may be started earlier than in a method in the related art, in which formation of an image is started after the quantity of the supplied toner is restored.

In the above-described image forming apparatus 1, the ratio of the volume of the toner to capacity of the toner cartridge, and the date when the toner is stored in the toner cartridge are used as the toner characteristics. However, it is not limited thereto. For example, similar operations may be performed when the weight of the toner in the toner cartridge is used instead of the ratio of the volume of the toner to capacity of the toner cartridge. In addition, the temperature or the humidity in the image forming apparatus 1 may be used. That is, if the temperature or the humidity is increased, the toner is easily aggregated and a case similar to the above-described case of “staying for a long period of time” occurs.

In the above-described image forming apparatus 1, the density detection sensor 17 that reads a toner image formed on the photosensitive drum 11 detects toner density, but it is not limited thereto. For example, the reference patch may be formed on the intermediate transfer belt 20 and a density detection sensor that reads the formed reference patch may be provided.

A sensor that measures the toner density may be provided in the developing device 14 and thus the toner density may be detected.

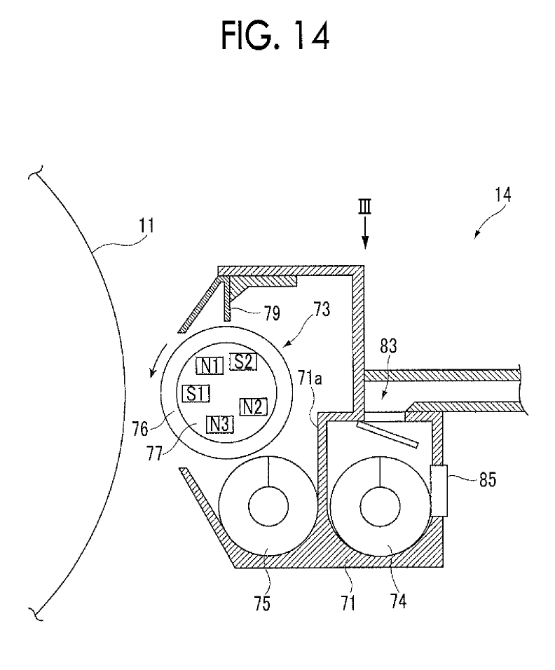

FIG. 14 is a diagram illustrating an example of the developing device 14 which includes a sensor that measures the toner density.

The developing device 14 illustrated in FIG. 14 includes a toner density sensor 85 as the sensor that measures the toner density. In the example illustrated in FIG. 14, a case where the toner density sensor 85 is provided so as to be adjacent to the first screw auger 74 is described. In this case, the toner density may be detected even when the above-described reference patch is not formed.

The processes performed by the above-described image forming apparatus 1 may be recognized as an image forming method in which a user is caused to select the condition regarding a time at which the image forming unit 10 which forms a toner image starts formation of a toner image after a toner cartridge is replaced, and the image forming unit 10 forms the toner image in accordance with the selected condition.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus configured with a replaceable toner storage section, the image forming apparatus comprising:
a toner image forming section configured to form an image using toner from the toner storage section;
a display configured to display information regarding status of the image forming unit;
an input device configured to allow a user to select a condition regarding a time at which the toner image forming section starts formation of the toner image, after the toner storage section has been replaced; and
a controller configured to control operation of the toner image forming section based at least on the selected condition from the input device, the controller further configured to perform the following functions:
acquire information regarding characteristics of the toner; and
control the display to indicate a period of time until a quantity of the toner supplied to the toner image forming section is sufficient, the period of time being predicted by the controller based on the information regarding the characteristics of the toner,
wherein the information regarding characteristics of the toner includes at least a date when the toner was first stored in the toner cartridge.

2. (canceled)

3. The image forming apparatus according to claim 1,
wherein the controller is configured to predict the period of time until the quantity of the toner supplied to the toner image forming section is sufficient, based on (a) the information regarding the characteristics of the toner and (b) a relationship between (i) a period of time since a supply of the toner to the toner image forming section and (ii) the quantity of the supplied toner.

4. The image forming apparatus according to claim 3, wherein
the controller is configured to predict the period of time until the quantity of the toner supplied to the toner image forming section is sufficient based further on a quantity of an insufficient toner density.

5. The image forming apparatus according to claim 1, wherein
the input device is configured to allow the user to select a case where the formation of the toner image is started, if a supply of the toner to the toner image forming section is started even when a quantity of the toner supplied to the toner image forming section is insufficient.

6. (canceled)

7. The image forming apparatus according to claim 3, wherein
the input device is configured to allow the user to select a case where the formation of the toner image is started, if the supply of the toner to the toner image forming section is started even when the quantity of the toner supplied to the toner image forming section is insufficient.

8. The image forming apparatus according to claim 4, wherein
the input device is configured to allow the user to select a case where the formation of the toner image is started, if the supply of the toner to the toner image forming section is started even when the quantity of the toner supplied to the toner image forming section is insufficient.

9. The image forming apparatus according to claim 1, wherein
the input device is configured to allow the user to select a case where the formation of the toner image is started, if a quantity of the toner used by the toner image forming section is sufficient from a viewpoint of a relationship with an image density, even when the quantity of the toner supplied to the toner image forming section is insufficient.

10. (canceled)

11. The image forming apparatus according to claim 3, wherein
the input device is configured to allow the user to select a case where formation of the toner image is started, if a quantity of the toner used by the toner image forming section is sufficient from a viewpoint of a relationship with an image density, even when the quantity of the toner supplied to the toner image forming section is insufficient.

12. The image forming apparatus according to claim 4, wherein
the input device is configured to allow the user to select a case where formation of the toner image is started, if a quantity of the toner used by the toner image forming section is sufficient from a viewpoint of a relationship with an image density, even when the quantity of the toner supplied to the toner image forming section is insufficient.

13. The image forming apparatus according to claim 5, wherein
the input device is configured to allow the user to select a case where formation of the toner image is started, if a quantity of the toner used by the toner image forming section is sufficient from a viewpoint of a relationship with an image density, even when the quantity of the toner supplied to the toner image forming section is insufficient.

14. The image forming apparatus according to claim 6, wherein
the input device is configured to allow the user to select a case where formation of the toner image is started, if a quantity of the toner used by the toner image forming section is sufficient from a viewpoint of a relationship with an image density, even when the quantity of the toner supplied to the toner image forming section is insufficient.

15. The image forming apparatus according to claim 7, wherein
the input device is configured to allow the user to select a case where formation of the toner image is started, if a quantity of the toner used by the toner image forming section is sufficient from a viewpoint of a relationship with an image density, even when the quantity of the toner supplied to the toner image forming section is insufficient.

16. The image forming apparatus according to claim 8, wherein
the input device is configured to allow the user to select a case where formation of the toner image is started, if a quantity of the toner used by the toner image forming section is sufficient from a viewpoint of a relationship with an image density, even when the quantity of the toner supplied to the toner image forming section is insufficient.

17. (canceled)

18. The image forming apparatus according to claim 3, wherein
the information regarding the characteristics of the toner includes at least one of a weight of the toner in the toner storage section that stores the toner, a ratio of a volume of the toner to capacity of the toner storage section, a date when the toner is stored in the toner storage section, a temperature of the image forming apparatus, and a humidity of the image forming apparatus.

19.-20. (canceled)

21. The image forming apparatus according to claim 1, wherein the information regarding characteristics of the toner includes at least both the date when the toner is stored in the toner cartridge and a ratio of a volume of the toner to a capacity of the toner storage section.
